(19) United States
(12) Patent Application Publication
(10) Pub. No.: US 2003/0179575 A1
(43) Pub. Date: Sep. 25, 2003

(54) Netted firework light

(75) Inventor: Peter K. H. Huang, Taipei (TW)

Correspondence Address: BRUCE H. TROXELL, SUITE 1404, 5205 LEESBURG PIKE, FALLS CHURCH, VA, 22041, US

(73) Assignee: Shining Blick Enterprise Co., Ltd.

(21) Appl. No.: 10/101,411

(22) Filed: Mar. 20, 2002

(51) Int. Cl. F21S 13/14

(52) U.S. Cl. 362/252; 362/251; 362/806

(57) ABSTRACT

A netted firework light in which a plurality of radially extending lamp strings form a netted light in cooperation with their conductors, wherein, at least one of the radially extending lamp strings are connected at the ends thereof with pending extension lamp strings with flashing functions to generate an effect of lightened firework under control of an electronic controller and to flash one by one from the lowest lamp bulb to the highest lamp bulb thereon, flashing is continued from the pending extension lamp string to the netted light, the netted light is mounted on a collapsible positioning frame mating in shape with the netted light, and the firework light with the positioning frame is packed up in a packing box.

### BACKGROUND OF THE INVENTION

1. Field of the invention

The present invention is related to a netted firework light, and especially to a firework light made from a plurality of lamp strings of low cost and with a viewing effect of a firework after mounting on a positioning frame as if the firework were ignited to explode, it is suitable especially for packing up in a small pack.

2. Description of the Prior Art

Earlier decorative lamps mostly have a lot of light beads on a single conductor, by electric connection of the conductor, the light beads illuminate or flash to obtain a decoration effect, the decoration effect of such conventional lamp strings is still monolithic and not vivid enough though. Decorative lamps used nowadays give the function of creating various illuminating letters or patterns through electronically controlled netting devices; decorative net lights or netting lamps used for this were disclosed in the U.S. Pat. Nos. 5,645,342 and 5,951,146. However, such decorative lamps normally are larger by size and cost higher.

And among lamp designing in the present days generally, for the purpose of more embodying, injection molding is used to make imitated figures (such as Santa Claus) or imitated articles (such as a meteor). And then the figures or articles are decorated with lamp beads individually, they display the images of Santa Claus or the meteor when are electrically turned on, such as is the case of the U.S. Pat. No. 5,712,770; however, such decorating things are fixed per se, the decoration effect of them is stationary, they are inferior in attraction.

A U.S. patent application Ser. No. 09/897,926 concerning a structure of firework light of a larger type which can generate an effect of lightened firework with a flashing function as the firework lightened in a ceremony has been filed for patent application by the applicant of the present application. The improved firework light or any of the conventional firework lights of such kind is a firework light of the larger type, it has a height of between 1.5 m to 3 m, while the stretching ranges of the radial rods of such a firework light each is about 0.6 m to 1.8 m. Such a firework light is cumbersome for manufacturing as well as cost high, and the largest trouble of it is resided in the huge volume thereof and inconvenience of transportation and storage.

### SUMMARY OF THE INVENTION

The object of the present invention is to provide a netted firework light, in which a plurality of radially extending lamp strings form a netted light in cooperation with their conductors, at least an extension lamp string are connected with the inner ends of the radially extending lamp strings with flashing function to generate an effect of lightened firework. The entire firework light can be mounted on a flexible positioning frame in order to have it installed at a desired location. The flexible positioning frame and the firework light can be packed up in a pack of a smaller volume in favor of transportation. Thereby, a plurality of lamp strings of low cost can be constructed to generate an effect of lightened firework, and can be packed up in a small volume and shipped by manufacturers and collapsed as well as stored by distributors or users.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is front view showing the preferred embodiment of FIG. 1 has been positioned;

FIG. 3 is a schematic view showing the present invention is stored in a pack;

FIG. 4 is perspective view of another preferred embodiment of the present invention; and

FIGS. 5-7 show preferred embodiments with various modeling of the netted firework lights of the present invention.

### DETAILED DESCRIPTION OF THE PREFERRED EMBODIMENT

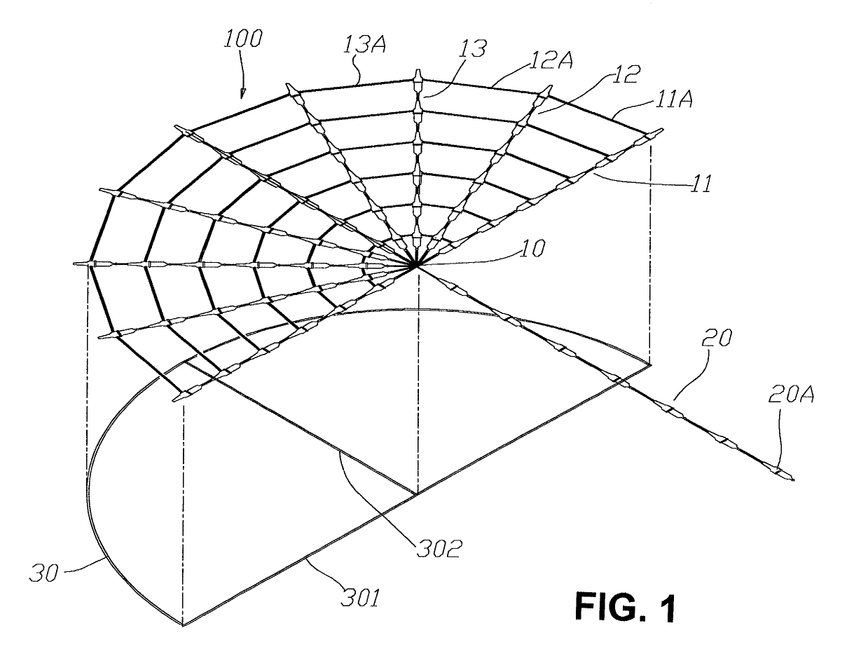

Referring to the preferred embodiment of the present invention in FIG. 1, a netted light 100 is formed from a plurality of radially extending lamp strings 11, 12, 13 . . . arranged generally in a semicircle in cooperation with their conductors 11A, 12A, 13A . . . . In this embodiment, the inner end of each of the radially extending lamp strings 11, 12, 13 . . . is extended to the center 10 of the netted light 100 and is connected with an extension lamp string 20.

In the electronic controller for such a netted light (not shown), the lamp bulbs 20A of the extension lamp string 20 can be controlled to flash one by one from the lowest one to the highest one, by the fact that the extension lamp string 20 is connected with the radially extending lamp strings 11, 12, 13 . . . , the lamp bulbs on the radially extending lamp strings 11, 12, 13 . . . flash one by one from the innermost one to the outermost one, after flashing for a period of time, all the lamp bulbs can be controlled in illuminating and extinguishing.

And in the preferred embodiment shown, a positioning frame 30 in mating the shape of the netted light 100 is provided. The positioning frame 30 is preferably made of flexible material to render it bendable. And in the preferred embodiment, the positioning frame 30 in mating the shape of the netted light 100 is in the shape of a semicircle. The positioning frame 30 has a semicircular part, a diametrical part 301 and a radius part 302 for reinforcement.

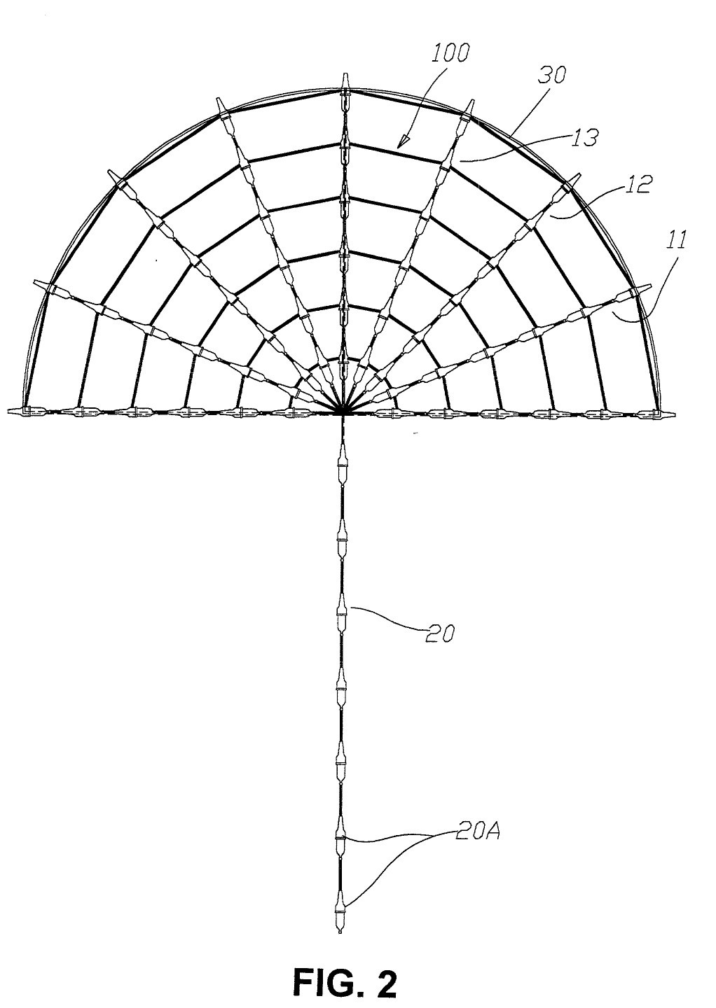

The firework light thereby can be stretched out on the positioning frame 30 and installed at a location (such as on a wall), the netted light 100 and the extension lamp string 20 can thereby be mounted and positioned in the mode as shown in FIG. 2. Hence the lamp string 20 can be controlled in flashing from the lowest to the highest lamp bulb thereof, and then the lamp bulbs on the netted light 100 flash in various modes.

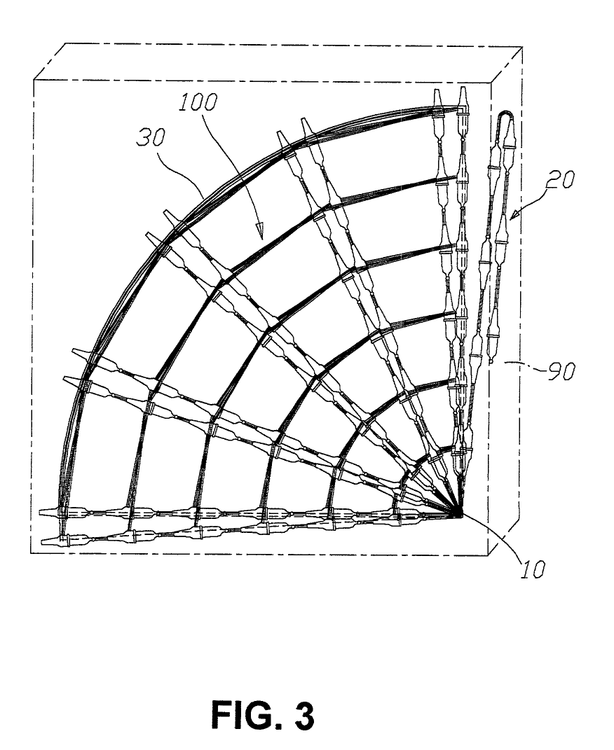

When not in use, or when a manufacturer makes such a product, the entire firework light including the netted light 100 and the extension lamp string 20 can be folded conveniently together with the collapsible positioning frame 30 and packed in a packing box 90 with a small volume (referring to FIG. 3).

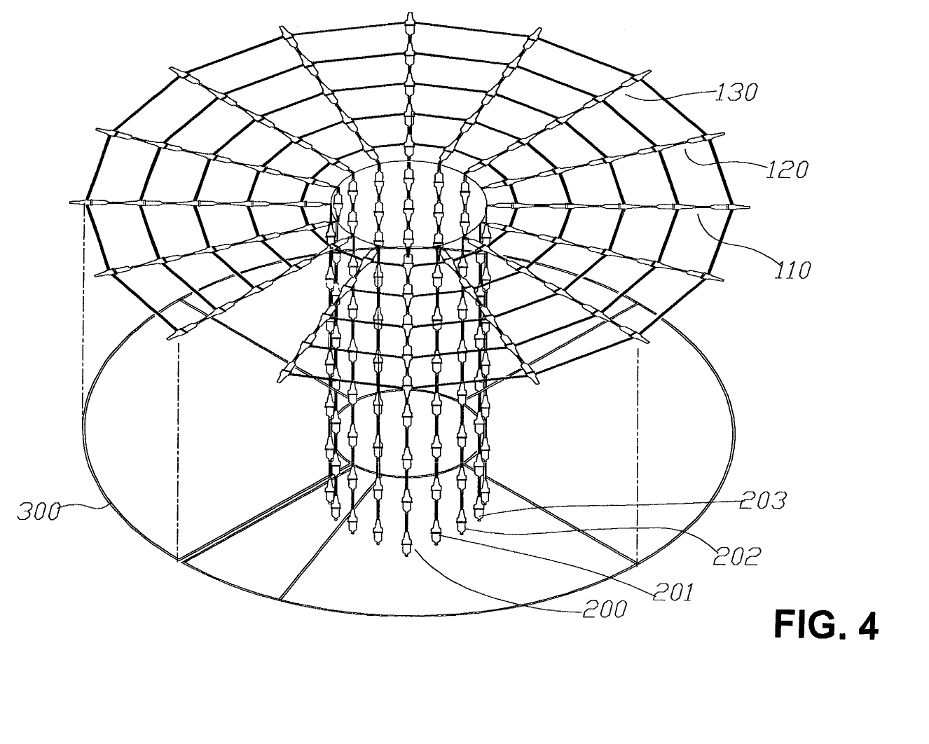

In another preferred embodiment of the present invention as shown in FIG. 4, a plurality of radially extending lamp strings 110, 120, 130 . . . are arranged generally in a circle in cooperation with their conductors to form a circular netted light. In this embodiment, the inner ends of the radially extending lamp strings 110, 120, 130 . . . are respectively connected with pending extension lamp strings 200, 201, 202 . . . . Thereby, the entire firework light can be more splendid and attractive when being controlled electrically to flash. This embodiment of netted firework light surely can be packed in a pack with a small volume.

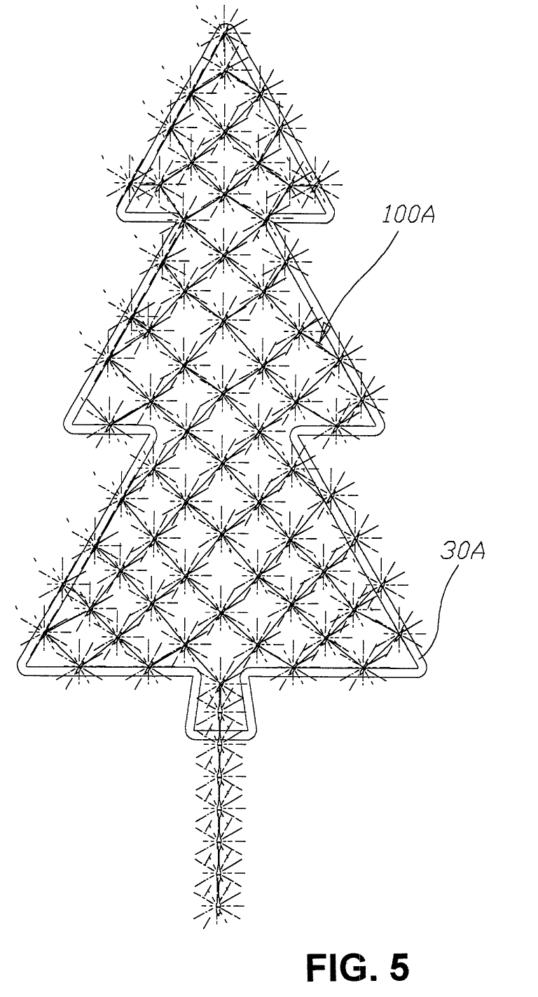

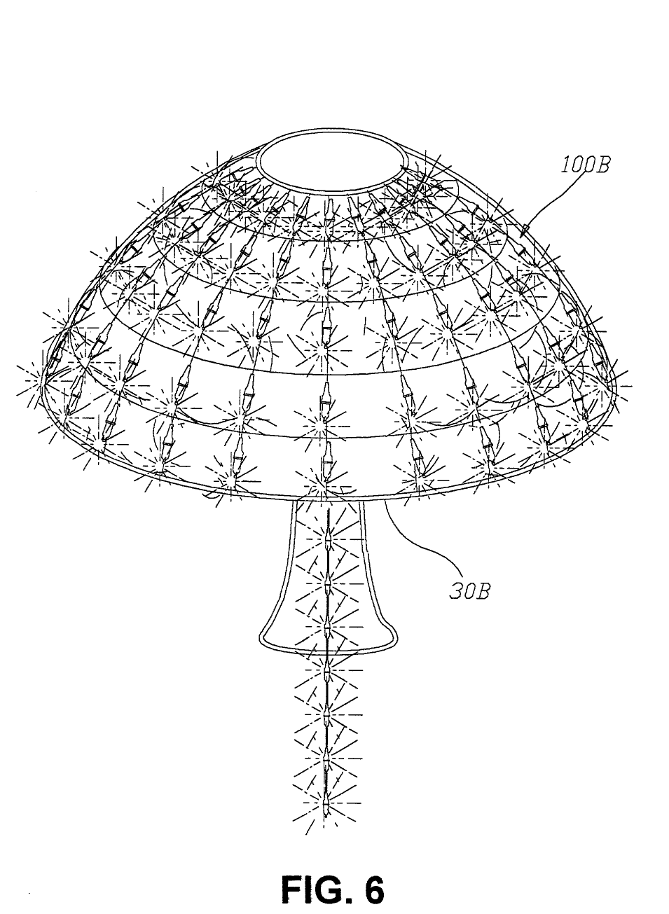

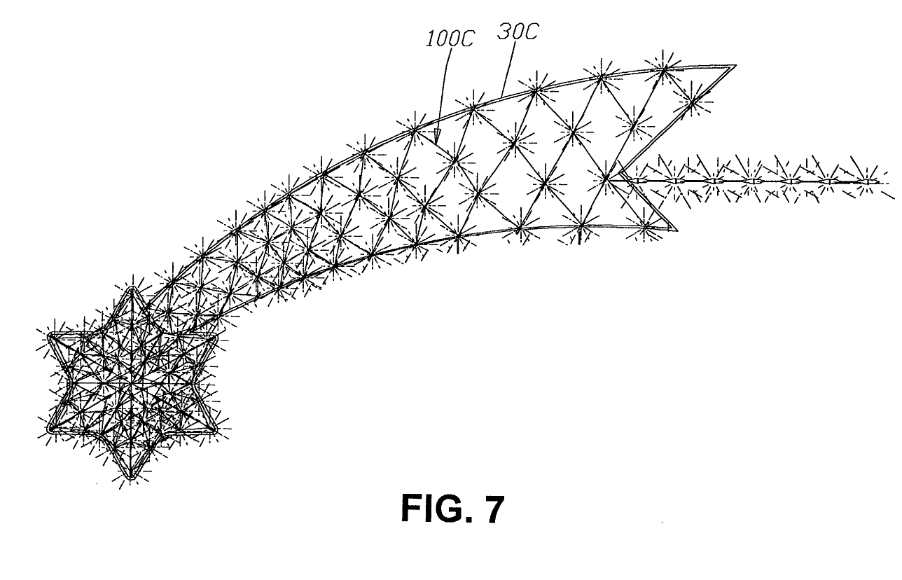

As shown in FIGS. 5-7, the present invention can also be in any of various netted lights of different shapes, such as the netted lights 10A, 100B and 100C in the modeling of a Christmas tree, a meteor etc. with their corresponding positioning frame 30A, 30B and 30C. Thereby, the present invention can be more varied; and is easier in getting various modeling.

The firework light of the present invention thereby can be made with a lot of lamp strings of low cost and with a viewing effect of a firework as if the firework were ignited to explode, and can be conveniently packed in a pack with a small volume for transportation and storage.

The embodiment cited above is only for illustrating a preferred embodiment. It will be apparent to those skilled in this art that various modifications or changes without departing from the spirit and scope of the present invention can be made to and shall fall within the scope of the appended claims of the present invention.

1. A netted firework light in which a plurality of radially extending lamp strings form a netted light in cooperation with their conductors, wherein, at least an extension lamp string is connected with the inner ends of said radially extending lamp strings to flash one by one from the lowest lamp bulb to the highest lamp bulb thereon under control of an electronic controller, flashing is continued from said extension lamp strings to said netted light, said netted light is mounted on a positioning frame mating in shape with said netted light.

2. The netted firework light as claimed in claim 1, wherein,
the inner end of each of said radially extending lamp strings is extended to the center of said netted light and is connected with an extension string.

3. The netted firework light as claimed in claim 1, wherein,
the inner end of each of said radially extending lamp strings is connected with a corresponding extension lamp string.

4. The netted firework light as claimed in claim 1, wherein,
said positioning frame of said netted light is collapsible.

5. The netted firework light as claimed in claim 4, wherein,
said firework light and said positioning frame are adapted to packing up in a small packing box.
